(19) United States
(12) Patent Application Publication
(10) Pub. No.: US 2012/0144337 A1
(43) Pub. Date: Jun. 7, 2012

(54) ADJUSTABLE TOUCH SCREEN KEYBOARD

(75) Inventors: Donald Gene ARCHER, Euless, TX (US); William D. YORK, Saginaw, TX (US)

(73) Assignee: VERIZON PATENT AND LICENSING INC., Basking Ridge, NJ (US)

(21) Appl. No.: 12/957,574

(22) Filed: Dec. 1, 2010

(51) Int. Cl. G06F 3/048

(52) U.S. Cl. 715/773

(57) ABSTRACT

A device displays keys, in a standard keyboard layout, on a touch screen of the device, and detects interaction of fingers, associated with a user of the device, with the touch screen. The device determines a type of interaction by the fingers, and reduces sizes of one or more of the keys when a finger contraction is the type of interaction by the fingers. The device displays, on the touch screen, a first reconfigured keyboard layout that includes the one or more keys that are reduced in size.

### BACKGROUND

Devices, such as mobile communication devices (e.g., cell phones, personal digital assistants (PDAs), smart phones, tablet computers, etc.), include touch sensitive input devices (e.g., touch sensitive interfaces or displays, touch screens, etc.). Touch screens are usually formed with either a resistive or capacitive film layer, located above a display, which is used to sense a touch of the user's finger or a stylus. Some touch screens enable the user to input information (e.g., text, numbers, etc.) via a keyboard or a keypad displayed on the touch screen. The size of a touch screen may be determined by the size of the device containing the touch screen. Larger touch screens may display a keyboard or keypad that is nearly full size (e.g., a keyboard with keys that are on three-quarter inch centers, have a key travel of at least 0.150 inches, and may not have a numerical keypad).

However, different users may have different sized hands (or fingers), which may make manipulating such keyboards or keypads difficult. In one example, users with larger hands (and fingers) may find that the keys arranged on the keyboard or keypad are too small or in too close proximity to one another. The closely-arranged keys may be difficult to manipulate by such large-handed users. For example, the user's finger (e.g., which may be larger than such keys) may accidently select keys adjacent to a desired key, which may cause incorrect input to the device. In another example, users with smaller hands (and fingers) may find that the keys arranged on the keyboard or keypad are spaced to far apart. The spaced keys may be difficult to manipulate by such small-handed users. Furthermore, different users may manipulate similar touch screens in different ways (e.g., via a single finger, via a thumb, via multiple fingers or thumbs, etc.). Thus, some users may experience even further difficulty in manipulating closely-arranged or spaced keys arranged on the keyboard or keypad.

### BRIEF DESCRIPTION OF THE DRAWINGS

FIG. 1 is a diagram of an example device in which systems and/or methods described herein may be implemented;

FIG. 2 is a diagram of example components of the device depicted in FIG. 1;

FIGS. 3A and 3B are diagrams of example components of a display of the device illustrated in FIG. 1;

FIGS. 4A-4H are diagrams of example layout reconfiguration operations capable of being performed by the device depicted in FIG. 1; and

FIGS. 5A-6 are flow charts of an example process for reconfiguring a touch screen layout according to implementations described herein.

### DETAILED DESCRIPTION OF PREFERRED EMBODIMENTS

The following detailed description refers to the accompanying drawings. The same reference numbers in different drawings may identify the same or similar elements.

Systems and/or methods described herein may reconfigure a layout of a touch screen of a device (e.g., a tablet computer, a smart phone, a cell phone, a PDA, a personal computer, a laptop computer, a remote control, etc.) so that the touch screen layout may be customized to a particular user. In one example, the systems and/or methods may enable a user to adjust a keyboard layout (e.g., displayed on the touch screen) using different touch gestures. For example, the different touch gestures may enable the user to adjust spacing, sizes, locations, and/or shapes of keys provided in the keyboard layout.

In one example implementation, the systems and/or methods may provide display elements (e.g., keys), in a standard keyboard layout, for display on a touch screen of a device, and may detect an interaction of a user's fingers with the touch screen. The systems and/or methods may determine a type of interaction with the fingers, such as, for example, the user separating the fingers, the user bringing the fingers closer together, or the user rotating the fingers. If finger separation is the determined interaction, the systems and/or methods may enlarge and/or reshape one or more display elements based on the finger separation, and may provide, for display on the touch screen, a reconfigured keyboard layout with the enlarged/reshaped display elements. If finger contraction is the determined interaction, the systems and/or methods may reduce and/or reshape one or more display elements based on the finger contraction, and may provide, for display on the touch screen, a reconfigured keyboard layout with the reduced/reshaped display elements. If finger rotation is the determined interaction, the systems and/or methods may reconfigure the display elements, based on the finger rotation, to define first and second portions of display elements, where the first portion is rotated counterclockwise and the second portion is rotated clockwise. The systems and/or methods may provide, for display on the touch screen, a reconfigured keyboard layout with the reconfigured display elements.

As used herein, the term “user” is intended to be broadly interpreted to include a device or a user of a device. The term “touch screen” is intended to be broadly interpreted to include a touch screen display, a touch sensitive input device, a touch sensitive interface, etc. The term “touch area,” as used herein, is intended to be broadly interpreted to include an area of a touch screen that contacts a user's finger when a user manipulates the touch screen. Furthermore, the term “display element,” as used herein, is intended to be broadly interpreted to include a key (e.g., of a keypad or keyboard), an icon, a button, a menu, and/or any other mechanism capable of being displayed by a touch screen and selected by a user.

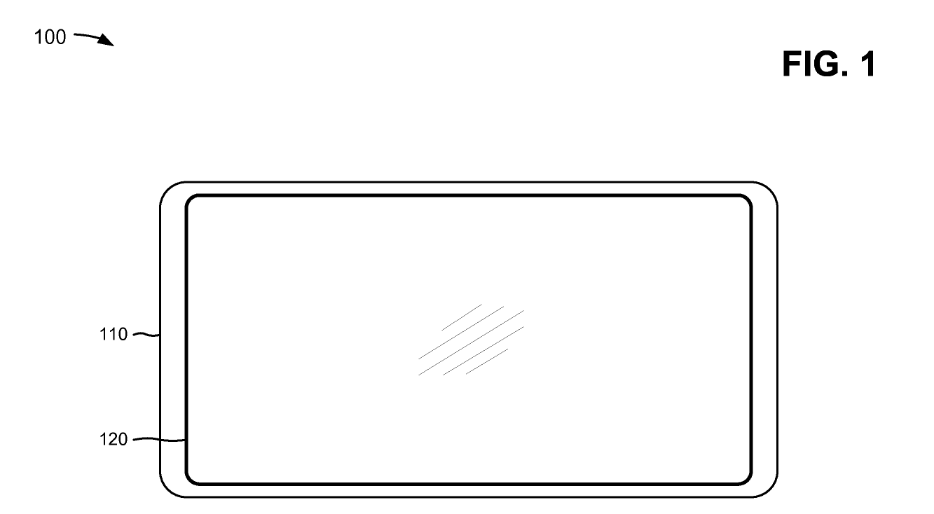

FIG. 1 is a diagram of an example device 100 in which systems and/or methods described herein may be implemented. Device 100 may include a radiotelephone, a personal communications system (PCS) terminal (e.g., that may combine a cellular radiotelephone with data processing and data communications capabilities), a PDA (e.g., that can include a radiotelephone, a pager, Internet/intranet access, etc.), a remote control (e.g., for a television), a portable gaming system, a global positioning system (GPS) device, a printer, a facsimile machine, a pager, a camera (e.g., a film camera or a digital camera), a video camera (e.g., a camcorder), a tablet computer, a smart phone, a calculator, binoculars, a telescope, a personal computer, a laptop computer, and/or any other device capable of utilizing a touch screen display.

As illustrated in FIG. 1, device 100 may include a housing 110 and a display 120. In other implementations, device 100 (e.g., depending on a type of device) may include other components, such as a keyboard, a keypad, a speaker, a microphone, a mouse, etc.

Housing 110 may protect the components of device 100 from outside elements. Housing 110 may include a structure configured to hold devices and components used in device 100, and may be formed from a variety of materials. For example, housing 110 may be formed from plastic, metal, or a composite, and may be configured to support display 120.

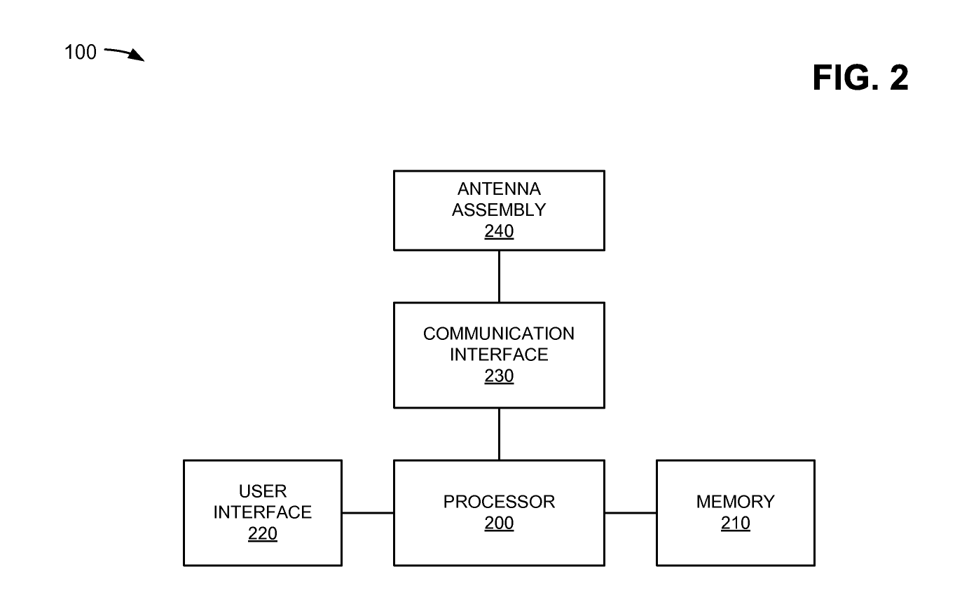

Display 120 may provide visual information to the user. For example, display 120 may display text input into device 100; text, images, video, and/or graphics received from another device; and/or information regarding incoming or outgoing calls or text messages, emails, media, games, phone books, address books, the current time, etc. In one implementation, display 120 may include a touch screen display that may be configured to receive a user input when the user touches display 120. For example, the user may provide an input to display 120 directly, such as via the user's finger, or via other devices, such as a stylus. User inputs received via display 120 may be processed by components and/or devices operating in device 100. The touch screen display may permit the user to interact with device 100 in order to cause device 100 to perform one or more operations. Further details of display 120 are provided below in connection with, for example, one or more of FIGS. 2-4H.

In one example implementation, device 100 may provide display elements (e.g., keys), in a standard keyboard layout, for display on display 120, and may detect an interaction of a user's fingers with display 120. Device 100 may determine a type of interaction with the fingers, such as, for example, the user separating the fingers, the user bringing the fingers closer together, or the user rotating the fingers. If finger separation is the determined interaction, device 100 may enlarge and/or reshape one or more display elements based on the finger separation, and may provide, for display on display 120, a reconfigured keyboard layout with the enlarged/reshaped display elements. If finger contraction is the determined interaction, device 100 may reduce and/or reshape one or more display elements based on the finger contraction, and may provide, for display on display 120, a reconfigured keyboard layout with the reduced/reshaped display elements. If finger rotation is the determined interaction, device 100 may reconfigure the display elements, based on the finger rotation, to define first and second portions of display elements, where the first portion is rotated counterclockwise and the second portion is rotated clockwise. Device 100 may provide, for display on display 120, a reconfigured keyboard layout with the reconfigured display elements.

Although FIG. 1 shows example components of device 100, in other implementations, device 100 may contain fewer components, different components, differently arranged components, or additional components than depicted in FIG. 1. Alternatively, or additionally, one or more components of device 100 may perform one or more other tasks described as being performed by one or more other components of device 100.

FIG. 2 is a diagram of example components of device 100. As illustrated, device 100 may include a processor 200, memory 210, a user interface 220, a communication interface 230, and/or an antenna assembly 240.

Processor 200 may include one or more processors, microprocessors, application-specific integrated circuits (ASICs), field-programmable gate arrays (FPGAs), or the like. Processor 200 may control operation of device 100 and its components in a manner described herein.

Memory 210 may include a random access memory (RAM), a read-only memory (ROM), and/or another type of memory to store data and instructions that may be used by processor 200.

User interface 220 may include mechanisms for inputting information to device 100 and/or for outputting information from device 100. Examples of input and output mechanisms might include buttons (e.g., control buttons, keys of a keypad, a joystick, etc.) or a touch screen interface (e.g., display 120) to permit data and control commands to be input into device 100; a speaker to receive electrical signals and output audio signals; a microphone to receive audio signals and output electrical signals; a display (e.g., display 120) to output visual information (e.g., text input into device 100); a vibrator to cause device 100 to vibrate; etc.

Communication interface 230 may include, for example, a transmitter that may convert baseband signals from processor 200 to radio frequency (RF) signals and/or a receiver that may convert RF signals to baseband signals. Alternatively, communication interface 230 may include a transceiver to perform functions of both a transmitter and a receiver. Communication interface 230 may connect to antenna assembly 240 for transmission and/or reception of the RF signals.

Antenna assembly 240 may include one or more antennas to transmit and/or receive RF signals over the air. Antenna assembly 240 may, for example, receive RF signals from communication interface 230 and transmit them over the air, and receive RF signals over the air and provide them to communication interface 230. In one implementation, for example, communication interface 230 may communicate with a network and/or devices connected to a network.

Device 100 may perform certain operations described herein in response to processor 200 executing software instructions of an application contained in a computer-readable medium, such as memory 210. A computer-readable medium may be defined as a non-transitory memory device. A memory device may include space within a single physical memory device or spread across multiple physical memory devices. The software instructions may be read into memory 210 from another computer-readable medium or from another device via communication interface 230. The software instructions contained in memory 210 may cause processor 200 to perform processes described herein. Alternatively, hardwired circuitry may be used in place of or in combination with software instructions to implement processes described herein. Thus, implementations described herein are not limited to any specific combination of hardware circuitry and software.

Although FIG. 2 shows example components of device 100, in other implementations, device 100 may contain fewer components, different components, differently arranged components, or additional components than depicted in FIG. 2. Alternatively, or additionally, one or more components of device 100 may perform one or more other tasks described as being performed by one or more other components of device 100.

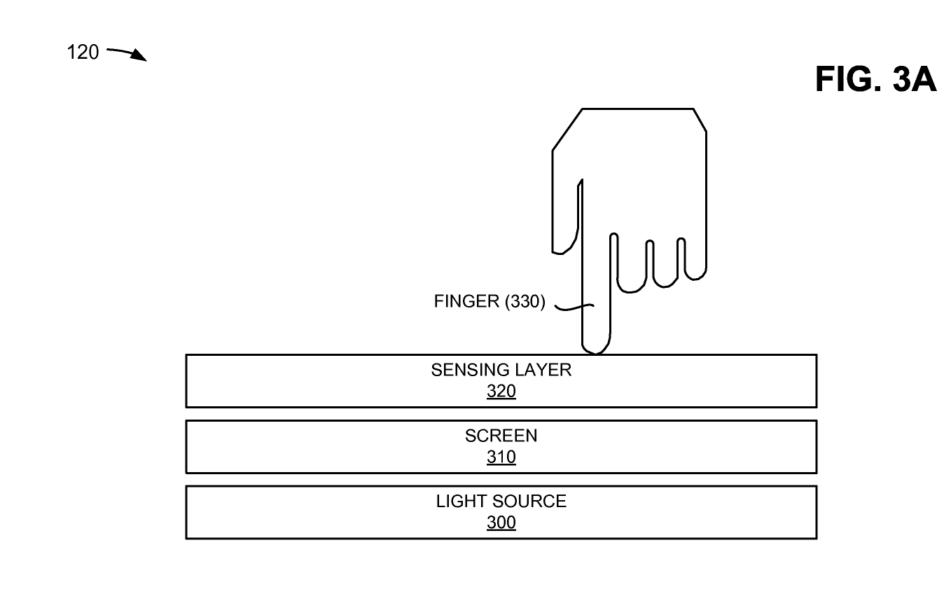

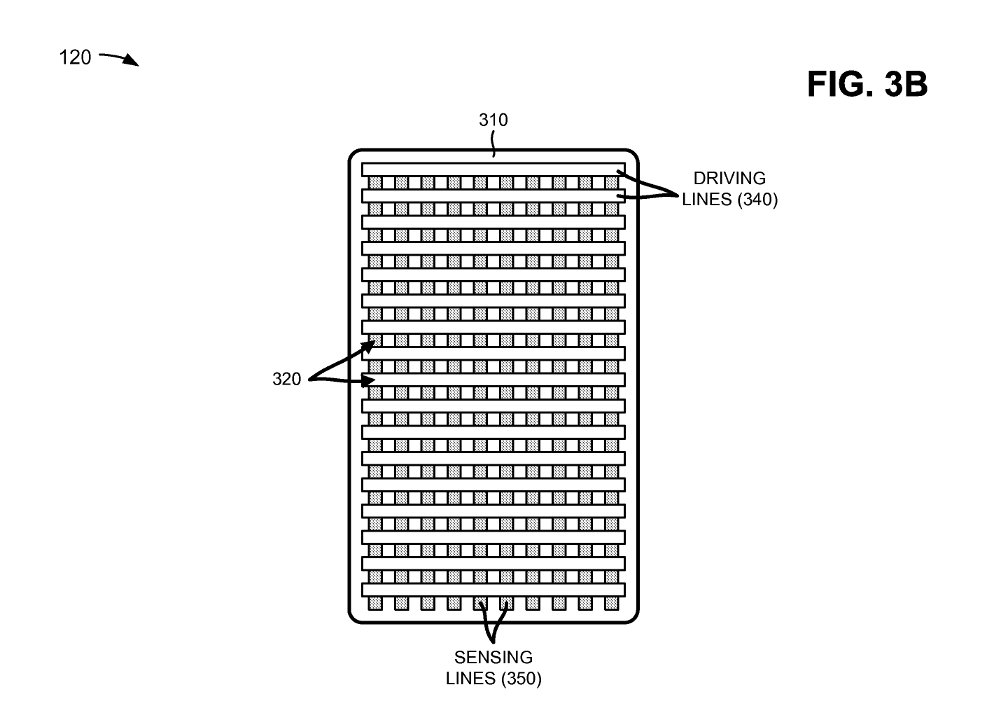

FIGS. 3A and 3B are diagrams of example components of display 120 of device 100. As shown, display 120 may include a light source 300, a screen 310, and/or a sensing layer 320.

Light source 300 may include a mechanism (e.g., a backlight) that provides backlighting to a lower surface of screen 310 in order to display information. For example, light source 300 may include one or more incandescent light bulbs, one or more light-emitting diodes (LEDs), an electroluminescent panel (ELP), one or more cold cathode fluorescent lamps (CCFL), one or more hot cathode fluorescent lamps (HCFL), etc. that illuminate portions of screen 310. Incandescent light bulbs may be used when very high brightness is desired. LEDs may be used in small, inexpensive lighting arrangements, and may include colored or white light. An ELP may be used for larger lighting arrangements or when even lighting is desired, and may be either colored or white. CCFLs may be used in large lighting arrangements and may be white in color. In another example, light source 300 may employ one or more diffusers or light guides to provide even lighting from an uneven source. In still another example, light source 300 can include any color light source (e.g., yellow, green, blue, white, etc.) or any combination of colored/non-colored light sources. The light provided by light source 300 may also be used to provide front lighting to an upper surface of screen 310 that faces a user.

Screen 310 may include any mechanism capable of providing visual information (e.g., text, images, video, incoming or outgoing calls, games, phone books, the current time, emails, etc.) to a user. For example, screen 310 may include a liquid crystal display (LCD), such as a thin film transistor (TFT) LCD, etc. In one example implementation, screen 310 may include a plastic substrate that arranges TFT on a metal foil (rather than on glass), which may permit screen 310 to recover its original shape after being bent. Screen 310 may include a color filter coated onto the plastic substrate, which may permit screen 310 to display color images. In other implementations, screen 310 may include a monochrome, flexible LCD.

In one implementation, screen 310 may include any number of color and/or monochrome pixels. In another implementation, screen 310 may include a passive-matrix structure or an active-matrix structure. In a further implementation, if screen 310 is a color array, each pixel may be divided into three cells, or subpixels, which may be colored red, green, and blue by additional filters (e.g., pigment filters, dye filters, metal oxide filters, etc.). Each subpixel may be controlled independently to yield numerous possible colors for each pixel. In other implementations, each pixel of screen 310 may include more or less than three subpixels of various colors other than red, green, and blue.

Sensing layer 320 may include a mechanism that detects the presence of a user's finger 330 (e.g., a thumb, an index finger, a middle finger, a ring finger, a pinkie finger, or multiple fingers) on display 120, detects the location (or touch area) of finger 330 on display 120, determines how many fingers a user has on display 120, etc. For example, sensing layer 320 may include a layer of capacitive material (e.g., provided under a protective covering (not shown)) that may experience a change in electrical charges (e.g., a change in the amount of charge stored) when finger 330 contacts sensing layer 320. In one example implementation, sensing layer 320 may include self capacitance circuitry that includes an array of electrodes and monitors changes in the array of electrodes when a user contacts sensing layer 320 (e.g., with finger 330). In another example implementation, as shown in FIG. 3B, sensing layer 320 may include a layer of driving lines 340 that carry current, and a separate layer of sensing lines 350 that detect changes in electrical charge when a user contacts sensing layer 320 (e.g., with finger 330).

Sensing layer 320 may sense a change associated with its electrical properties every time a user contacts sensing layer 320, and may provide this information to processor 200 and/or memory 210. Processor 200 may utilize this information to determine a shape, a size, and/or a location of a user's finger (or fingers) on display 120. In one example implementation, processor 200 may calculate touch area(s) associated with a user's finger(s) based on information received from sensing layer 320, and may reconfigure display element(s) (e.g., keys, icons, etc.) associated with display 120 based on the calculated touch area(s).

Although FIGS. 3A and 3B show example components of display 120, in other implementations, display 120 may contain fewer components, different components, differently arranged components, or additional components than depicted in FIGS. 3A and 3B. Alternatively, or additionally, one or more components of display 120 may perform one or more other tasks described as being performed by one or more other components of display 120.

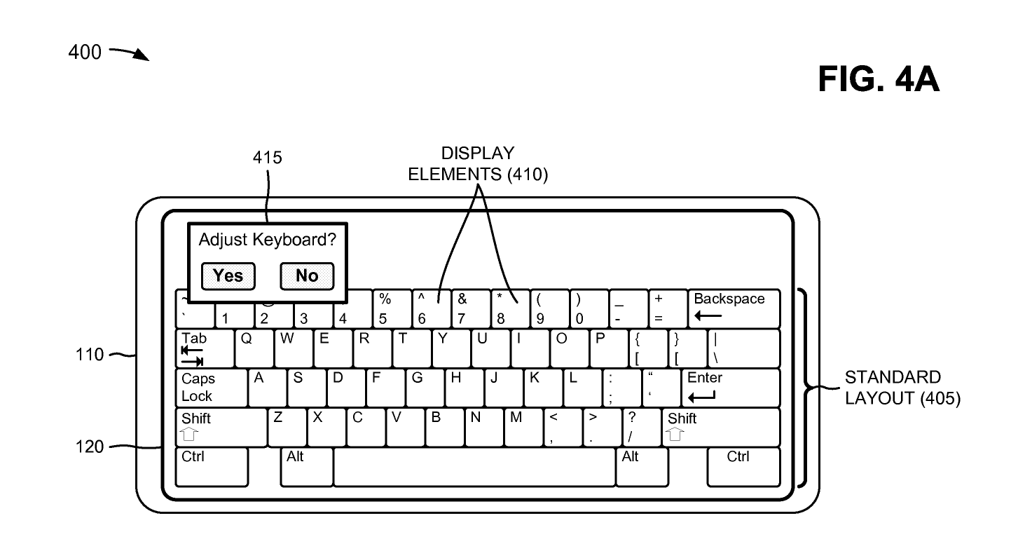

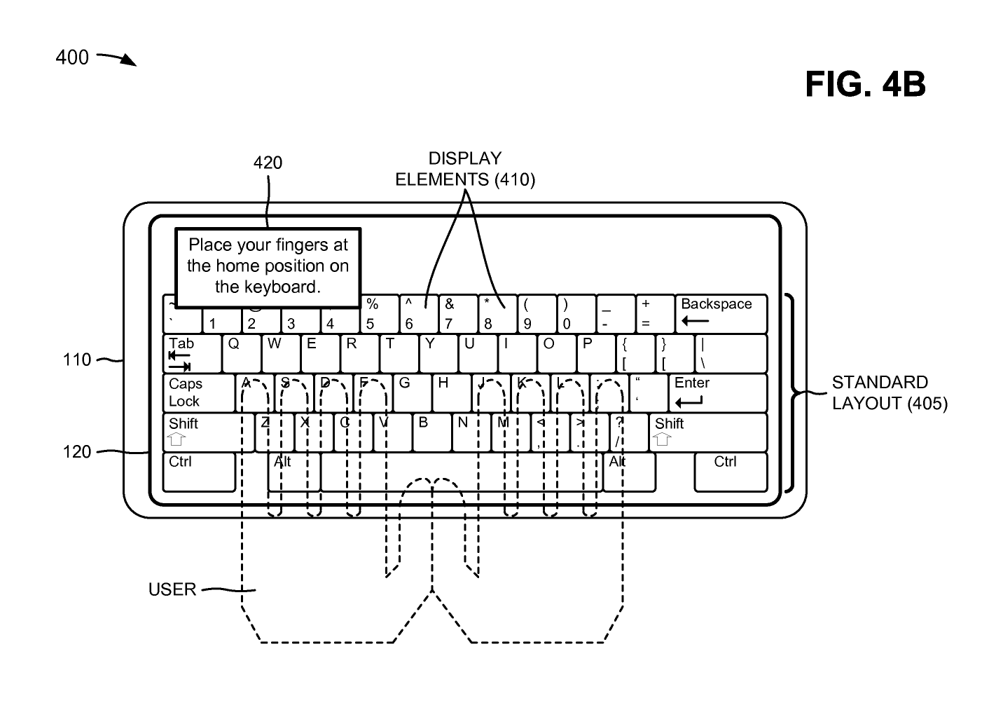

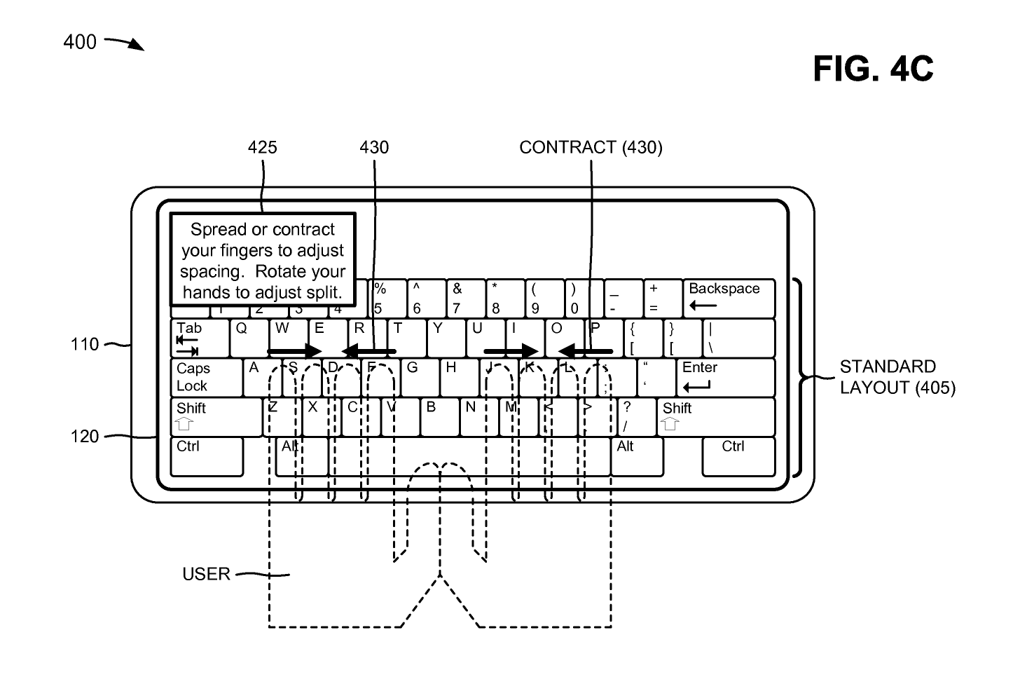

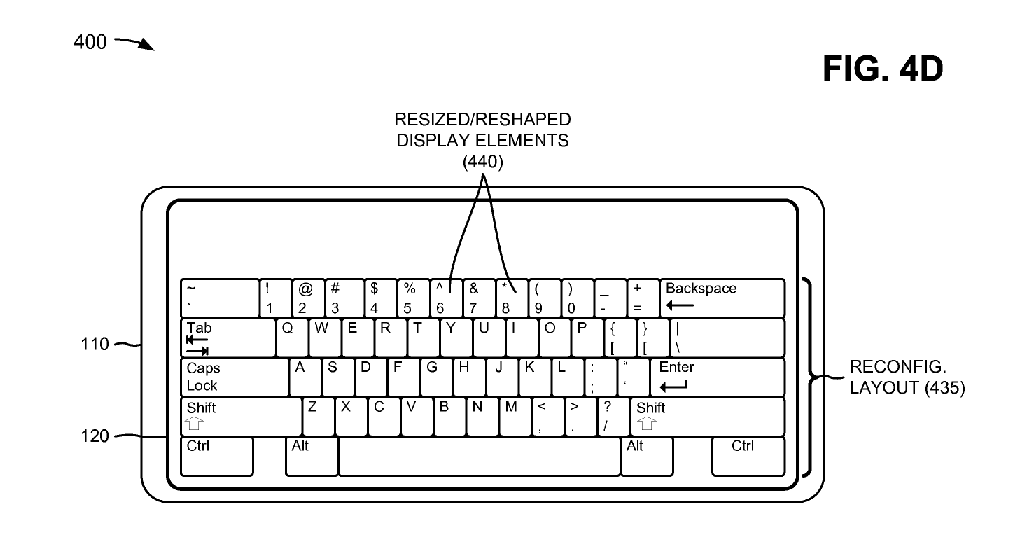

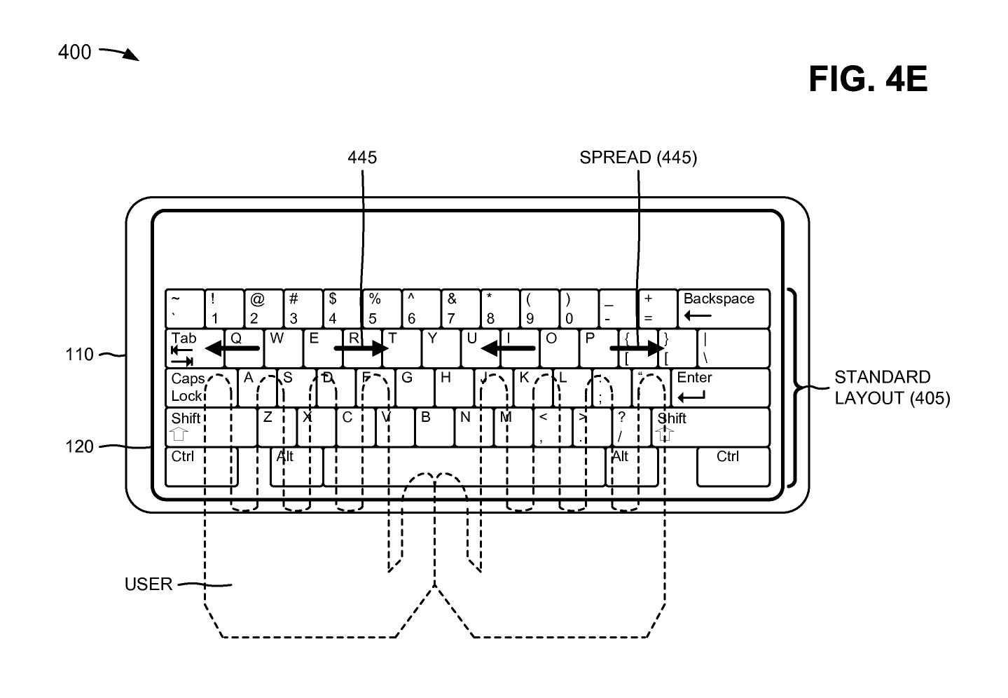

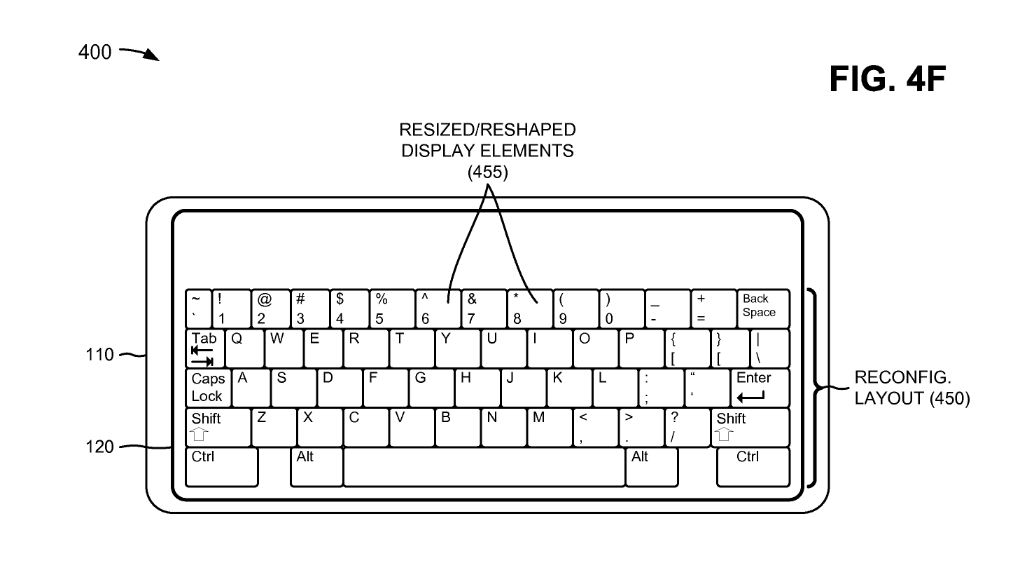

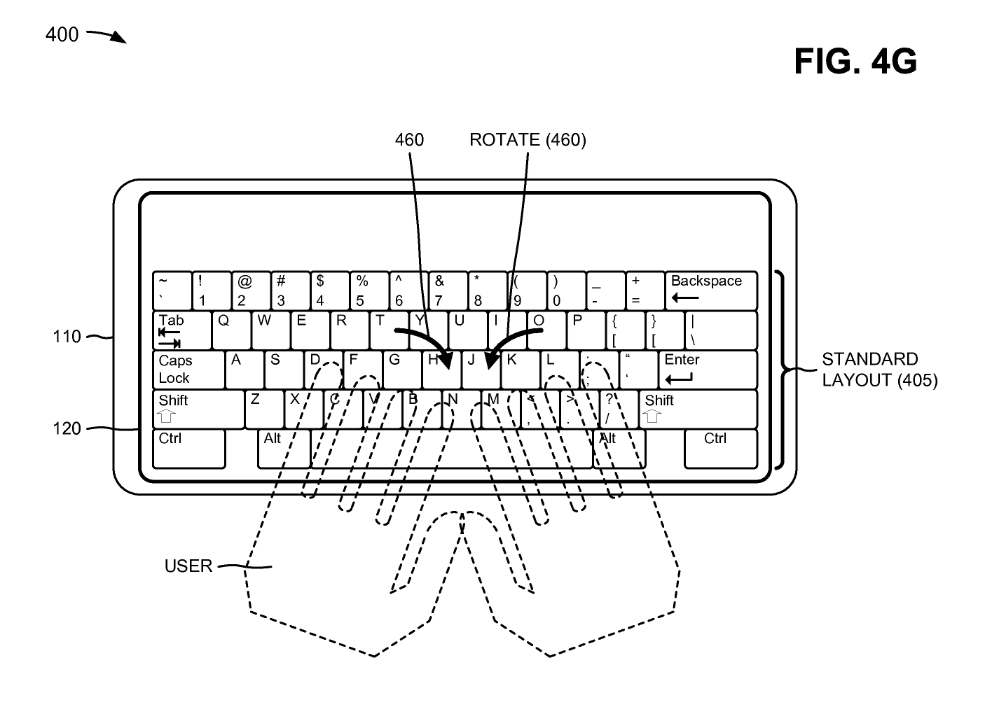

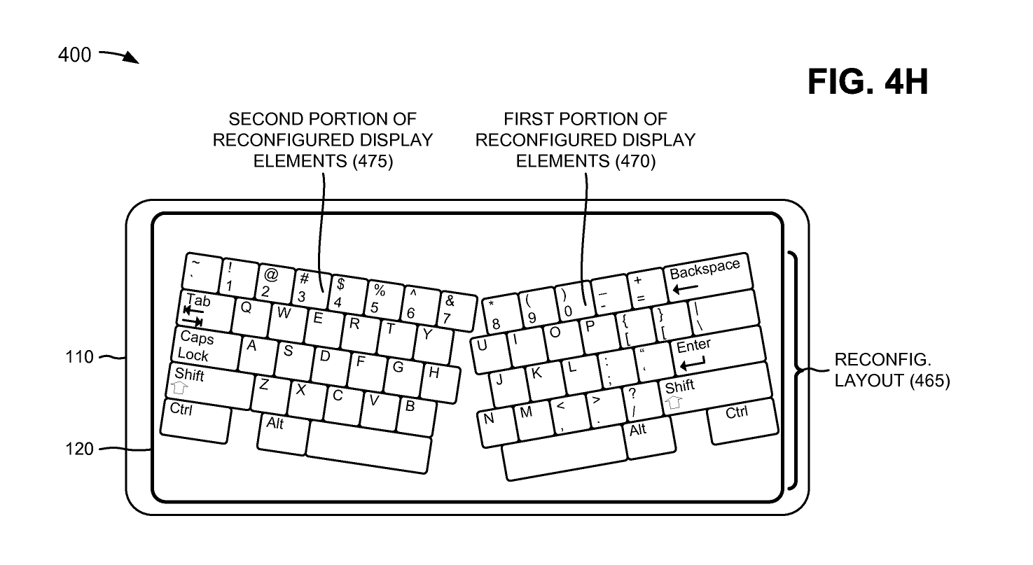

FIGS. 4A-4H are diagrams of example layout reconfiguration operations 400 capable of being performed by device 100. In one implementation, the operations described in connection with FIGS. 4A-4H may be performed by one or more components of device 110 (depicted in FIG. 2). As shown in FIGS. 4A-4H, device 100 may include housing 110 and display 120. Housing 110 and display 120 may include the features described above in connection with, for example, one or more of FIGS. 1, 3A, and 3B. As further shown in FIG. 4A, display 120 may display a standard layout 405 (e.g., of one or more display elements 410) and/or an edit mode window 415.

Standard layout 405 may include an arrangement of evenly-spaced, evenly-aligned, and/or uniformly-shaped display elements 410. In one example, display elements 410 of standard layout 405 may be too small and/or arranged in close proximity to one another, which may make display elements 410 difficult to manipulate for a user with large hands (or fingers). In another example, display elements 410 of standard layout 405 may be too large and/or spaced too far apart, which may make display elements 410 difficult to manipulate for a user with small hands (or fingers). In still another example, display elements 410 of standard layout 405 may not be ergonomically arranged for some users. In one example implementation, as shown in FIG. 4A, standard layout 405 may include a standard QWERTY-like keyboard layout (e.g., a traditional configuration of typewriter or computer keyboard keys) of keys (e.g., display elements 410). Each of the keys may be associated with and may display a corresponding character (e.g., a corresponding QWERTY character). In another example implementation, standard layout 405 may include icons (e.g., display elements 410) associated with executable applications capable of being executed by device 100. The icons may display information associated with the executable application corresponding to the icons.

Each of display elements 410 may include a key (e.g., of a keypad or keyboard), an icon, a button, a menu, and/or any other mechanism capable of being displayed by display 120 and selected by a user. For example, as shown in FIG. 4A, display elements 410 may include keys of a standard QWERTY-like keyboard layout.

Edit mode window 415 may include a window or another similar mechanism that provides an option to reconfigure the layout (e.g., standard layout 405) displayed by device 100. In one implementation, edit mode window 415 may be displayed when a user selects an edit mode (e.g., for standard layout 405) from a settings menu of device 100. As shown in FIG. 4A, edit mode window 415 may request whether the user wishes to adjust the keyboard (e.g., standard layout 405) provided on display 120, and may provide “Yes” and “No” selection mechanisms (e.g., icons, buttons, etc.). If the user selects the “Yes” selection mechanism, device 100 may request the user to interact with display 120 (e.g., via the user's fingers), and may detect the interaction of the fingers with display 120. If the user selects the “No” selection mechanism, device 100 may remove edit mode window 415.

If the user chooses the “Yes” selection mechanism, device 100 may provide an instructional window 420 on display 120, as shown in FIG. 4B. Instructional window 420 may include a window or another similar mechanism that provides instructions to the user. For example, as shown in FIG. 4B, instructional window 420 may instruct the user to “Place your fingers at the home position on the keyboard.” As further shown in FIG. 4B, the user may place his/her fingers at the home position on the keyboard (e.g., standard layout 405). For a standard QWERTY-like keyboard layout (e.g., standard layout 405), the home position may correspond to placing a left hand pinkie finger on letter “A,” a left hand ring finger on letter “S,” a left hand middle finger on letter “D,” a left hand index finger on letter “F,” a right hand index finger on letter “J,” a right hand middle finger on letter “K,” a right hand ring finger on letter “L,” and a right hand pinkie finger on symbol “;”.

Once the user places his/her fingers at the home position on the keyboard (e.g., standard layout 405), device 100 may provide another instructional window 425 on display 120, as shown in FIG. 4C. Instructional window 425 may include a window or another similar mechanism that provides instructions to the user. For example, as shown in FIG. 4C, instructional window 425 may instruct the user to “Spread or contract your fingers to adjust spacing. Rotate your hands to adjust split.” Based on instructional window 425, the user may contract his/her fingers, spread his/her fingers, and/or rotate his/her hands. As the user contracts his/her fingers, spread his/her fingers, and/or rotate his/her hands, device 100 may detect an interaction of the user's fingers with display 120, may determine the type of interaction by the user's fingers, and may alter the configuration of standard layout 405 and/or display elements 410.

As shown in FIG. 4C, a user (e.g., a user with smaller hands or fingers) may contract his/her fingers by moving his/her fingers closer to each other, as indicated by reference number 430. As the user contracts his/her fingers, device 100 may detect an interaction of the user's fingers with display 120, and may determine the type of interaction by the user's fingers. For example, device 100 may determine finger contraction 430 based on the interaction of the user's fingers. Device 100 may resize (e.g., reduce in size) and/or reshape one or more display elements 410 based on finger contraction 430. Device 100 may display a reconfigured layout 435 (e.g., of keyboard), with resized (e.g., reduced) and/or reshaped display elements 440, on display 120, as shown in FIG. 4D. In one example implementation, reconfigured layout 435 may enable users with smaller hands or fingers to more easily manipulate the keys (e.g., resized/reshaped display elements 440) of the keyboard.

As shown in FIG. 4E, a user (e.g., a user with larger hands or fingers) may spread or separate his/her fingers by moving his/her fingers away or apart from each other, as indicated by reference number 445. As the user spreads or separates his/her fingers, device 100 may detect an interaction of the user's fingers with display 120, and may determine the type of interaction by the user's fingers. For example, device 100 may determine finger separation 445 based on the interaction of the user's fingers. Device 100 may resize (e.g., enlarge in size) and/or reshape one or more display elements 410 based on finger separation 445. Device 100 may display a reconfigured layout 450 (e.g., of keyboard), with resized (e.g., enlarged) and/or reshaped display elements 455, on display 120, as shown in FIG. 4F. In one example, to make room for resized/reshaped display elements 455, one or more longer keys on the edges of the keyboard (e.g., the “Enter” key, the “Backspace” key, the “Shift” key, the “Caps Lock” key, the “Tab” key, etc.) may be shortened from their size in standard layout 405. In one example implementation, reconfigured layout 450 may enable users with larger hands or fingers to more easily manipulate the keys (e.g., resized/reshaped display elements 455) of the keyboard.

In one example implementation, the user may adjust how much display elements 410 are reduced, enlarged, and/or reshaped based on the user's interactions with display. For example, display elements 410 may be reduced and/or reshaped more as the user decreases the spacing between the user's fingers. In another example, display elements 410 may be enlarged and/or reshaped more as the user increases the spacing between the user's fingers. Such adjustments may be continuously performed by device 100 “on the fly” so that the user can find a keyboard configuration that suits the user. Once the user finds the appropriate keyboard configuration, the user may remove his/her fingers from display and the adjustments may cease.

As shown in FIG. 4G, a user may rotate his/her fingers by rotating his/her right hand (e.g., in a counterclockwise direction) and left hand (e.g., in a clockwise direction), as indicated by reference number 460. As the user rotates his/her fingers, device 100 may detect an interaction of the user's fingers with display 120, and may determine the type of interaction by the user's fingers. For example, device 100 may determine finger rotation 460 based on the interaction of the user's fingers. Device 100 may reconfigure one or more display elements 410 based on finger rotation 460. For example, based on finger rotation 460, device 100 may define a first portion of reconfigured display elements 410 and a second portion of reconfigured display elements 410. The first portion of the reconfigured display elements 410 may be rotated in a counterclockwise direction, and the second portion of the reconfigured display elements 410 may be rotated in a clockwise direction. Device 100 may display a reconfigured layout 465 (e.g., of keyboard), with a first portion 470 of reconfigured display elements and a second portion 475 of reconfigured display elements, on display 120, as shown in FIG. 4H.

In one example, first portion 470 of reconfigured display elements may be rotated in a counterclockwise direction, and second portion 475 of reconfigured display elements may be rotated in a clockwise direction. The user may adjust the degree of rotation of first portion 470 and second portion 475 (e.g., by adjusting rotation of the user's hands), and may adjust how far first portion 470 is spaced from second portion 475 (e.g., by manipulating portions 470/475 with the user's fingers). In one example implementation, reconfigured layout 465 may provide a more ergonomic layout of the keyboard (e.g., than the straight standard layout 405).

Although FIGS. 4A-4H show example layout reconfiguration operations 400 associated with device 100, in other implementations, device 100 may perform fewer operations, different operations, or additional operations than depicted in FIGS. 4A-4H.

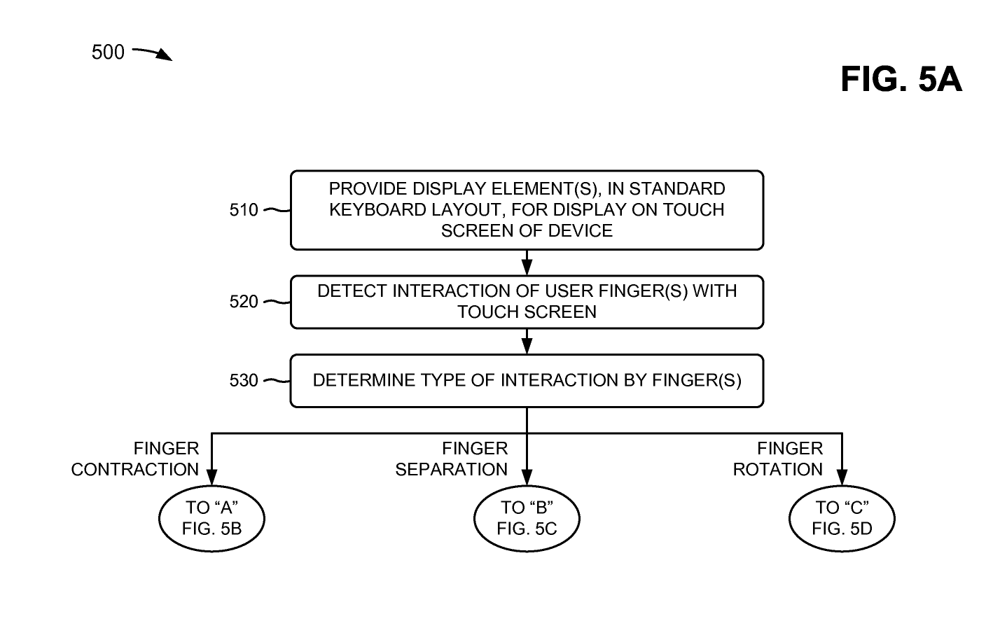

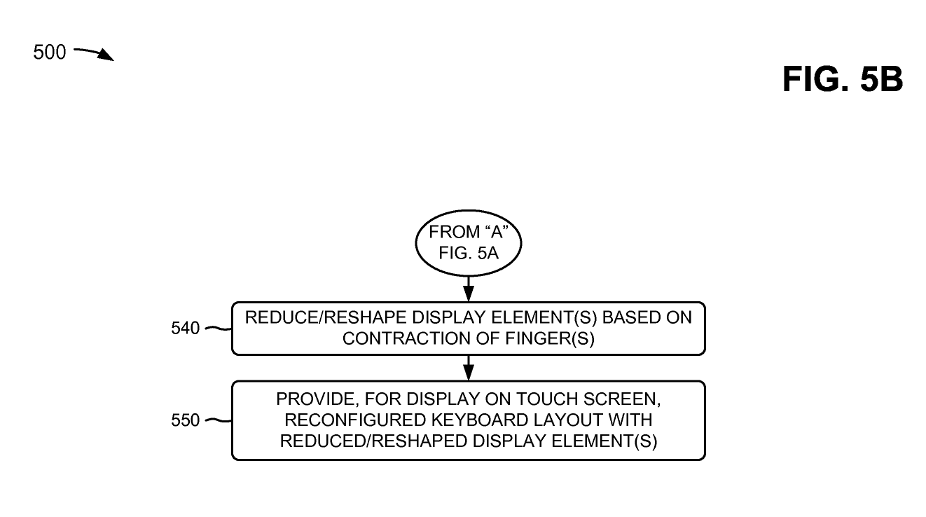

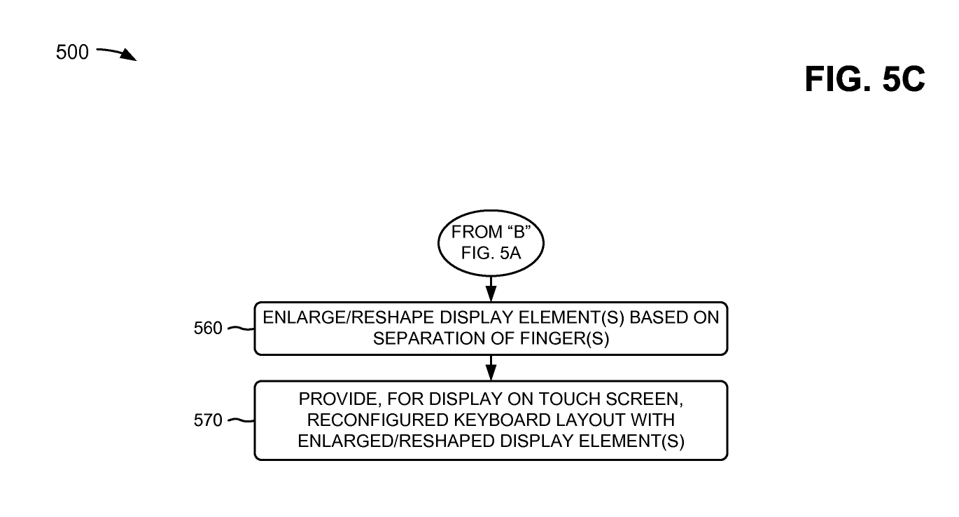

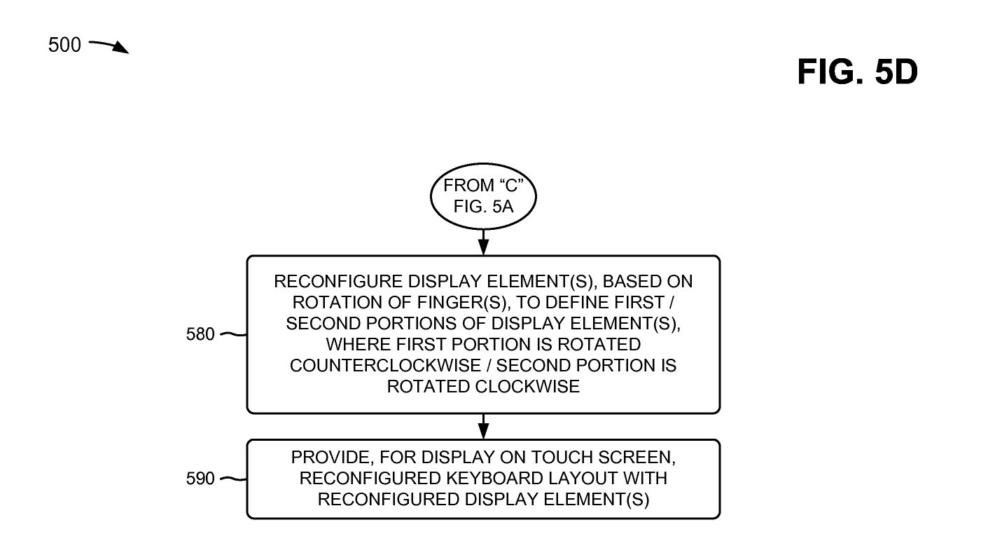

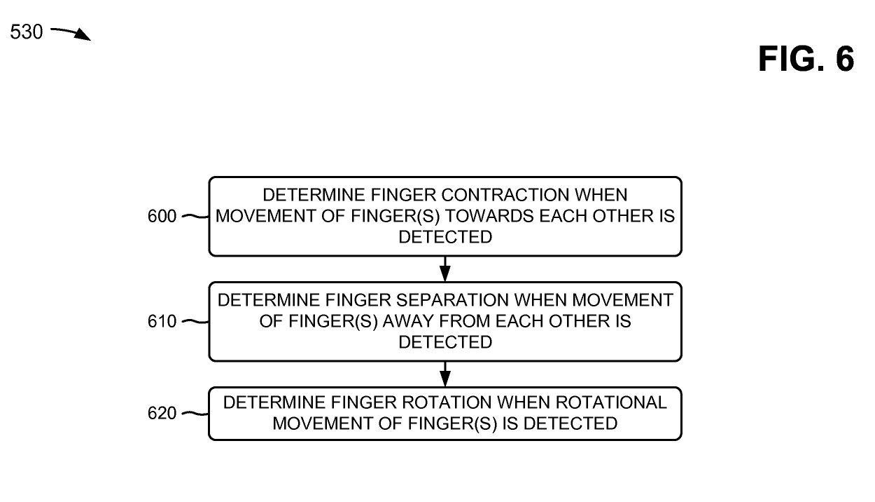

FIGS. 5A-6 are flow charts of an example process 500 for reconfiguring a touch screen layout according to implementations described herein. In one implementation, process 500 may be performed by device 100.

As illustrated in FIG. 5A, process 500 may include providing display element(s), in a standard keyboard layout, for display on a touch screen of a device (block 510), detecting an interaction of finger(s) of a user with the touch screen (block 520), and determining a type of interaction by the finger(s) (block 530). For example, in implementations described above in connection with FIGS. 4A-4C, display 120 may display standard layout 405 of one or more display elements 410. Standard layout 405 may include an arrangement of evenly-spaced, evenly-aligned, and/or uniformly-shaped display elements 410. In one example, standard layout 405 may include a standard QWERTY-like keyboard layout (e.g., a traditional configuration of typewriter or computer keyboard keys) of keys (e.g., display elements 410). Based on instructional window 425, the user may contract his/her fingers, spread his/her fingers, and/or rotate his/her hands. As the user contracts his/her fingers spread his/her fingers, and/or rotate his/her hands, device 100 may detect an interaction of the user's fingers with display 120, and may determine the type of interaction by the user's fingers.

As shown in FIGS. 5A and 5B, if a finger contraction is the determined type of interaction by the finger(s) (block 530—FINGER CONTRACTION), process 500 may include reducing and/or reshaping the display element(s) based on the contraction of the finger(s) (block 540), and providing, for display on the touch screen, a reconfigured keyboard layout with the reduced/reshaped display element(s) (block 550). For example, in implementations described above in connection with FIGS. 4C and 4D, a user (e.g., a user with smaller hands or fingers) may contract his/her fingers by moving his/her fingers closer to each other, as indicated by reference number 430. As the user contracts his/her fingers, device 100 may detect an interaction of the user's fingers with display 120, and may determine finger contraction 430 based on the interaction of the user's fingers. Device 100 may resize (e.g., reduce in size) and/or reshape one or more display elements 410 based on finger contraction 430. Device 100 may display reconfigured layout 435 (e.g., of keyboard), with resized (e.g., reduced) and/or reshaped display elements 440, on display 120. In one example, reconfigured layout 435 may enable users with smaller hands or fingers to more easily manipulate the keys (e.g., resized/reshaped display elements 440) of the keyboard.

As shown in FIGS. 5A and 5C, if a finger separation is the determined type of interaction by the finger(s) (block 530—FINGER SEPARATION), process 500 may include enlarging and/or reshaping the display element(s) based on the separation of the finger(s) (block 560), and providing, for display on the touch screen, a reconfigured keyboard layout with the enlarged/reshaped display element(s) (block 570). For example, in implementations described above in connection with FIGS. 4E and 4F, a user (e.g., a user with larger hands or fingers) may spread or separate his/her fingers by moving his/her fingers away or apart from each other, as indicated by reference number 445. As the user spreads or separates his/her fingers, device 100 may detect an interaction of the user's fingers with display 120, and may determine finger separation 445 based on the interaction of the user's fingers. Device 100 may resize (e.g., enlarge in size) and/or reshape one or more display elements 410 based on finger separation 445. Device 100 may display reconfigured layout 450 (e.g., of keyboard), with resized (e.g., enlarged) and/or reshaped display elements 455, on display 120. In one example, reconfigured layout 450 may enable users with larger hands or fingers to more easily manipulate the keys (e.g., resized/reshaped display elements 455) of the keyboard.

As shown in FIGS. 5A and 5D, if a finger rotation is the determined type of interaction by the finger(s) (block 530—FINGER ROTATION), process 500 may include reconfiguring the display element(s), based on the finger rotation, to define first and second portions of the display element(s), where the first portion is rotated counterclockwise and the second portion is rotated clockwise (block 580), and providing, for display on the touch screen, a reconfigured keyboard layout with the reconfigured display element(s) (block 590). For example, in implementations described above in connection with FIGS. 4G and 4H, a user may rotate his/her fingers by rotating his/her right hand (e.g., in a counterclockwise direction) and left hand (e.g., in a clockwise direction), as indicated by reference number 460. As the user rotates his/her fingers, device 100 may detect an interaction of the user's fingers with display 120, and may determine finger rotation 460 based on the interaction of the user's fingers. Device 100 may reconfigure one or more display elements 410 based on finger rotation 460. In one example, based on finger rotation 460, device 100 may define a first portion of reconfigured display elements 410 and a second portion of reconfigured display elements 410. The first portion of the reconfigured display elements 410 may be rotated in a counterclockwise direction, and the second portion of the reconfigured display elements 410 may be rotated in a clockwise direction. Device 100 may display a reconfigured layout 465 (e.g., of keyboard), with first portion 470 of reconfigured display elements and second portion 475 of reconfigured display elements, on display 120.

Process block 530 may include the process blocks illustrated in FIG. 6. As shown in FIG. 6, process block 530 may include determining the finger contraction when movement of the finger(s) towards each other is detected (block 600), determining the finger separation when movement of the finger(s) away from each other is detected (block 610), and determining the finger rotation when rotational movement of the finger(s) is detected (block 620). For example, in implementations described above in connection with FIGS. 4C, 4E, and 4G, a user (e.g., a user with smaller hands or fingers) may contract his/her fingers by moving his/her fingers closer to each other, as indicated by reference number 430. As the user contracts his/her fingers, device 100 may detect an interaction of the user's fingers with display 120, and may determine finger contraction 430 based on the interaction of the user's fingers. A user (e.g., a user with larger hands or fingers) may spread or separate his/her fingers by moving his/her fingers away or apart from each other, as indicated by reference number 445. As the user spreads or separates his/her fingers, device 100 may detect an interaction of the user's fingers with display 120, and may determine finger separation 445 based on the interaction of the user's fingers. A user may rotate his/her fingers by rotating his/her right hand (e.g., in a counterclockwise direction) and left hand (e.g., in a clockwise direction), as indicated by reference number 460. As the user rotates his/her fingers, device 100 may detect an interaction of the user's fingers with display 120, and may determine finger rotation 460 based on the interaction of the user's fingers.

Systems and/or methods described herein may reconfigure a layout of a touch screen of a device (e.g., a tablet computer, a smart phone, a cell phone, a PDA, a personal computer, a laptop computer, a remote control, etc.) so that the touch screen layout may be customized to a particular user. In one example, the systems and/or methods may enable a user to adjust a keyboard layout (e.g., displayed on the touch screen) using different touch gestures. For example, the different touch gestures may enable the user to adjust spacing, sizes, locations, and/or shapes of keys provided in the keyboard layout.

The foregoing description of implementations provides illustration and description, but is not intended to be exhaustive or to limit the invention to the precise form disclosed. Modifications and variations are possible in light of the above teachings or may be acquired from practice of the invention.

For example, while series of blocks have been described with regard to FIGS. 5A-6, the order of the blocks may be modified in other implementations. Further, non-dependent blocks may be performed in parallel.

It will be apparent that example aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Further, certain portions of the invention may be implemented as a “component” or “logic” that performs one or more functions. These components or logic may include hardware, such as a processor, an ASIC, or a FPGA, or a combination of hardware and software.

Even though particular combinations of features are recited in the claims and/or disclosed in the specification, these combinations are not intended to limit the disclosure of the invention. In fact, many of these features may be combined in ways not specifically recited in the claims and/or disclosed in the specification. Although each dependent claim listed below may directly depend on only one other claim, the disclosure of the invention includes each dependent claim in combination with every other claim in the claim set.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method implemented by a device, the method comprising:
displaying display elements, in a standard keyboard layout, on a touch screen associated with the device;
detecting interaction of fingers, associated with a user of the device, with the touch screen;
determining, by the device, a type of interaction by the fingers;
reducing, by the device, sizes of one or more of the display elements when a finger contraction is the type of interaction by the fingers; and
displaying, on the touch screen, a first reconfigured keyboard layout that includes the one or more display elements that are reduced in size.

2. The method of claim 1, further comprising:
enlarging sizes of one or more of the display elements when a finger separation is the type of interaction by the fingers; and
displaying, on the touch screen and when the finger separation is the type of interaction by the fingers, a second reconfigured keyboard layout that includes the one or more display elements that are enlarged in size.

3. The method of claim 1, further comprising:
reconfiguring the display elements when a finger rotation is the type of interaction by the fingers, where reconfiguring the display elements includes:
defining a first portion of the display elements,
rotating the first portion of the display elements in a counterclockwise direction,
defining a second, different portion of the display elements, and
rotating the second portion of the display elements in a clockwise direction; and
displaying, on the touch screen and when the finger rotation is the type of interaction by the fingers, a third reconfigured keyboard layout that includes the reconfigured display elements.

4. The method of claim 3, where the third reconfigured keyboard layout comprises an ergonomic keyboard layout.

5. The method of claim 1, where each of the one or more display elements comprises a key associated with the standard keyboard layout displayed on the touch screen.

6. The method of claim 1, where detecting interaction of fingers comprises:
providing instructions to the user to contract the fingers, spread the fingers, or rotate the fingers;
receiving, based on the instructions, user performance of one of the finger contraction, a finger separation, or a finger rotation; and
detecting the interaction of the fingers with the touch screen based on the user performance.

7. The method of claim 1, where determining a type of interaction by the fingers comprises:
determining the finger contraction when movement of the fingers towards each other is detected;
determining a finger separation when movement of the fingers away from each other is detected; and
determining a finger rotation when rotational movement of the fingers is detected.

8. The method of claim 1, where the touch screen comprises a capacitive touch screen.

9. A device comprising:
a touch screen;
a memory to store a plurality of instructions; and
a processor to execute instructions in the memory to:
display keys, in a standard keyboard layout, on the touch screen,
detect interaction of fingers, associated with a user of the device, with the touch screen,
determine a type of interaction by the fingers,
enlarge sizes of one or more of the keys when a finger separation is the type of interaction by the fingers, and
display, on the touch screen and when the finger separation is the type of interaction by the fingers, a first reconfigured keyboard layout that includes the one or more keys that are enlarged in size.

10. The device of claim 9, where the processor is further to execute instructions in the memory to:
reduce sizes of one or more of the keys when a finger contraction is the type of interaction by the fingers, and
display, on the touch screen and when the finger contraction is the type of interaction by the fingers, a second reconfigured keyboard layout that includes the one or more keys that are reduced in size.

11. The device of claim 9, where the processor is further to execute instructions in the memory to:
reconfigure the keys when a finger rotation is the type of interaction by the fingers, and
display, on the touch screen and when the finger rotation is the type of interaction by the fingers, a third reconfigured keyboard layout that includes the reconfigured keys.

12. The device of claim 11, where, when reconfiguring the keys, the processor is further to execute instructions in the memory to:
define a first portion of the keys,
rotate the first portion of the keys in a counterclockwise direction,
define a second, different portion of the keys, and
rotate the second portion of the keys in a clockwise direction.

13. The device of claim 12, where the third reconfigured keyboard layout comprises an ergonomic keyboard layout.

14. The device of claim 9, where, when detecting interaction of fingers, the processor is further to execute instructions in the memory to:
provide instructions to the user to contract the fingers, spread the fingers, or rotate the fingers,
receive, based on the instructions, user performance of one of a finger contraction, the finger separation, or a finger rotation, and
detect the interaction of the fingers with the touch screen based on the user performance.

15. The device of claim 9, where, when determining a type of interaction by the fingers, the processor is further to execute instructions in the memory to:
determine a finger contraction when movement of the fingers towards each other is detected,
determine the finger separation when movement of the fingers away from each other is detected, and
determine a finger rotation when rotational movement of the fingers is detected.

16. One or more non-transitory computer-readable media storing instructions executable by one or more processors of a device, the media storing one or more instructions for:
displaying display elements, in a standard keyboard layout, on a touch screen associated with the device;
detecting interaction of fingers, associated with a user of the device, with the touch screen;
determining a type of interaction by the fingers;
reducing sizes of one or more of the display elements when a finger contraction is the type of interaction by the fingers; and
displaying, on the touch screen, a first reconfigured keyboard layout that includes the one or more display elements that are reduced in size.

17. The media of claim 16, where the media further stores one or more instructions for:
enlarging sizes of one or more of the display elements when a finger separation is the type of interaction by the fingers; and
displaying, on the touch screen and when the finger separation is the type of interaction by the fingers, a second reconfigured keyboard layout that includes the one or more display elements that are enlarged in size.

18. The media of claim 16, where the media further stores one or more instructions for:
reconfiguring the display elements when a finger rotation is the type of interaction by the fingers; and
displaying, on the touch screen and when the finger rotation is the type of interaction by the fingers, a third reconfigured keyboard layout that includes the reconfigured display elements.

19. The media of claim 18, where the one or more instructions for reconfiguring the display elements comprises one or more instructions for:
defining a first portion of the display elements,
rotating the first portion of the display elements in a counterclockwise direction,
defining a second, different portion of the display elements, and
rotating the second portion of the display elements in a clockwise direction

20. The media of claim 18, where the third reconfigured keyboard layout comprises an ergonomic keyboard layout.

21. The media of claim 16, where each of the one or more display elements comprises a key associated with the standard keyboard layout displayed on the touch screen.

22. The media of claim 16, where the one or more instructions for detecting interaction of fingers comprise one or more instructions for:
providing information to the user to contract the fingers, spread the fingers, or rotate the fingers;
receiving, based on the information, user performance of one of the finger contraction, a finger separation, or a finger rotation; and
detecting the interaction of the fingers with the touch screen based on the user performance.

23. The media of claim 16, where the one or more instructions for determining a type of interaction by the fingers comprise one or more instructions for:
determining the finger contraction when movement of the fingers towards each other is detected;
determining a finger separation when movement of the fingers away from each other is detected; and
determining a finger rotation when rotational movement of the fingers is detected.
